(19) United States
(12) Patent Application Publication
(10) Pub. No.: US 2006/0083474 A1
(43) Pub. Date: Apr. 20, 2006

(54) Potassium free zinc silicate glasses for ion-exchange processes

(75) Inventors: Eli Arad, Or Akiva (IL); Andrey Lipovskii, Or Akiva (IL); Dmitry Tagantsev, Or Akiva (IL)

Correspondence Address: PEARL COHEN ZEDEK, LLP, 1500 BROADWAY 12TH FLOOR, NEW YORK, NY, 10036, US

(73) Assignee: Color Chip (Israel) Ltd., Or Akiva (IL)

(21) Appl. No.: 10/501,953

(22) PCT Filed: Jan. 22, 2003
(86) PCT No.: PCT/IL03/00055

§ 371 Date: Nov. 28, 2005

Related U.S. Application Data
(60) Provisional application No. 60/349,342, filed on Jan. 22, 2002.

(51) Int. Cl. G02B 6/10

(52) U.S. Cl. 385/132; 385/141

(57) ABSTRACT

A fluorinated zinc-silicate glass having a composition, expressed in molar percent, of essentially from about 49 to about 69% SiO₂, from about 2% to about 30% ZnO, from about 3.9 to about 18% Al₂O₃, from about 10% to about 16.7% Na₂O, from about 0% to about 13% B₂O₃, from about 0% to about 0.8% MgO, from about 0% to about 0.7% BaO, from about 0% to about 3% ZrO₂, from about 0% to about 6.7% CaO, from about 0% to about 0.11% As₂O₃, from about 0% to about 0.07% Sb₃O₃, from about 0% to about 3% NaF and from about 0% to about 3.9% AlF₃. The glass can be prepared in optical quality slabs, is chemically durable in water, NaNO₃ salt melts and boiling NaOH, and has a refractive index close to that of the optical fiber to reduce coupling losses. The glass includes Na as a single alkali ion species exchangeable for silver in an ion-exchange process that provides a sufficient index change for waveguiding.

### FIELD AND BACKGROUND OF THE INVENTION

The present invention relates to optical materials, in particular to optical materials used in optical telecommunication systems. More specifically, the present invention relates to optical glasses used in integrated optical waveguides.

Recent achievements in optical engineering and fast development of optical telecommunication systems have resulted in the growth of practical interest in integrated optics. Integrated optical structures can be treated as elements used for distributing and controlling signals in fiber optical networks, for amplifying and multiplexing/de-multiplexing of these signals, for optical sensing, etc. While the concept of integrated optical structures and devices of this kind is properly developed, and application-specific requirements are formulated, an essential gap exists between theoretical design and applications. Filling this gap will allow for constructing fast optical telecommunication networks of higher information capacity, for increasing reliability of both optical networks and other systems using integrated optical chips, and, finally, will lead to essential progress in optical information and telecommunication systems. However this development is limited by the properties and characteristics of the materials being presently used for the formation of integrated optical waveguides (IOWs). Optical glass is cheap, can be easily used for the formation of IOWs with ion-exchange technique, and has a refractive index that allows effective coupling of the waveguides with optical fibers, etc. It is therefore potentially the most suitable material for manufacturing the majority of integrated-optical chips. However, effective usage of glasses in integrated optics requires these glasses to satisfy specific requirements: the glass has to be simple in manufacturing, and to demonstrate chemical stability in the processes of ion-exchanged waveguide formation, and in patterning with standard photolithography. Exchanged silver ions have to be stable in the glass. The glass should also have proper ion-exchange characteristics, i.e. a proper magnitude of diffusion coefficient and its dependence on the concentration of dopant cations, and an increase in the refractive index upon ion-exchange. Existing glasses, which in the main were not developed specifically for integrated optics, cannot satisfy these requirements, and the absence of proper glass restricts the development of optical telecommunications.

A crucial aspect in the development of optical components by ion-exchange on a glass substrate is the composition of the glass used. The glass composition should fulfill these criteria:
1. Sufficient refractive index change upon ion-exchange, i.e. sufficient content of exchangeable alkali. Since necessary index change and low stresses are achievable in Ag-for-Na ion-exchange, a suitable glass should contain 6 mol % or more of Na₂O.
2. No alkali metal other than sodium (Na). Since Ag-for-K or Na-for-K exchanges cause structural stress in the glass that results in birefringence, a glass that contains only Na (and no other alkali metal) is desirable. Another disadvantage of multi-alkali ion glasses is that exchange processes involving more then one alkali metal ion are very hard to model. Therefore, designing process parameters are extremely difficult, and circular symmetry of the exchanged ion distribution may be impossible to achieve.
3. Formation of optical quality slabs, i.e. uniformity of composition, absence of bubbles, micro-bubbles, and phase separation, and no stresses. This requirement imposes limitations on the melting temperature and viscosity of the glass-forming melt.
4. Stability of the silver ion in the glass: the electrons are donated to the silver ions from the valence band of the glass host. Non-bridging oxygen atoms introduce high-energy states at the top of the valence band. Glass that would not tend to reduce silver should have low content on non-bridging oxygen atoms (NBOs). In general terms, such glass should be less basic, i.e., contain high electro-negativity species [J. A. Duffy and M. D. Ingram, J. Non-Crystalline Solids, Vol. 21, p. 373, 1976] so that the energy level of the valence band is lower, increasing the energy gap for the electron transfer reaction. Alkali-containing silicate glasses can be NBO-free, if they contain three-valence network formers (or network intermediates) such as aluminum and boron [R. Araujo, Applied Optics, Vol. 31 (25), p. 5221, 1992] or a two-valence network former i.e., zinc in alumino-silicates [B. M. G. Smets, Glastechn. Ber. Vol. 56k, p. 1023, 1983, and G. A. C. M. Spierings and M. J. van Bommel, J. Non-Crystalline Solids, Vol. 113, p. 37, 1989].
5. Chemical durability of the glass, which enables its processing (exposure to acids, bases and salts during cleaning, mask removal, ion-exchange process and polishing).
6. Refractive index close to that of the optical fiber to reduce coupling losses.

Several glass compositions have been produced in prior art as substrates for ion-exchange processes. These include boro-silicates such as BK7 and K8 (Catalogue “USSR Colorless optical glass” G. T. Petrovsky, Ed., Moscow, 1990), alumino-boro-silicates like BGG31 and UV2743 (Mitsunami Glass Co.) and Zinc-silicates such as Corning 211, Schott IOG-10, and K15 (catalogue above). Most of these glasses contain the oxides of both sodium and potassium, and hence do not meet criterion 2 above. The reason for including two alkali metals in the glass is that incorporation of sodium alone in alumino-silicate and zinc silicate results in high melting temperature and high viscosity, which make the preparation of optical-quality glass difficult, and because these compositions have a wider glass forming region. Potassium-free glasses that are available or described in literature include the alumino-silicates (BGG31 and UV2743). However, they suffer from the disadvantages of high melting temperature and high melt viscosity, their industrial production being more complicated. Another disadvantage is that the chemical durability of boron-containing glasses in basic environments is inferior.

Beside the alumino-boro-silicates, other glasses that contain only one alkali metal exist, and their compositions are described by N. V. Nikonorov (see table 6 in Glass Physics and Chemistry, Vol. 25 (1), p. 16, 1999). However, glasses such as ZNS, ZGS, GNS, GaS, GS, TiG and AG (ibid) have refractive indices much higher than the index of an optical fiber (˜1.6-1.7 compared with 1.47 of the optical fiber) and therefore do not meet criterion 6 above.

As mentioned, zinc-silicate glasses suitable for ion-exchange are commercially available (Corning 0211, Schott IOG-10, and K15). They contain both Na and K to prevent the high melting temperature and its disadvantages (but do not meet criterion 2 above). Corning glass 211 contains 7.2 molar or mole percent (mol %) Na and 4.8 mol % K (manufacturer data). Schott's IOG-10 contains 10 mol % Na and 6 mol % K, while K15's contains 6.52 weight percent (wt %) Na and 12.04 wt % K (see Nikonorov above).

U.S. Pat. No. 6,128,430 describes a rare-earth doped alumino-silicate glass that contains 0-10 mol % ZnO and up to 15 wt % fluorine aimed to flatten gain. To our knowledge, there are no prior art potassium-free or fluorinated zinc-silicate glasses suitable for ion-exchange. Zinc and fluorine are mentioned only as minor and non-essential additives to glasses for the automotive industry or in the architectural field, e.g. in U.S. Pat. Nos. 5,837,629 and 5,830,814.

There is thus a widely recognized need for, and it would be highly advantageous to have, a potassium-free silicate glass for ion-exchange that does not suffer from the above disadvantages.

### SUMMARY OF THE INVENTION

According to the present invention there is provided a fluorinated zinc-silicate glass having a composition comprised essentially, in molar percent, of about 50 to 69% SiO₂, 0 to 13% B₂O₃, 2 to 6.50% Al₂O₃, 0 to 3.90% AlF₃, 10.40 to 17% Na₂O, 0 to 3% NaF, 0 to 18% ZnO, 0 to 3.20% ZrO₂, 0 to 0.80% MgO, 0 to 0.66% BaO, 0 to 6.72% CaO, 0 to 0.075% Sb₂O₃, and 0.08 to 0.11% As₂O₃.

According to the present invention there is provided an optical article fabricated in a planar slab of a fluorinated zinc-silicate glass by an ion-exchange process, the zinc-silicate glass characterized by having a single alkali ion species for said ion-exchange.

According to one feature of the optical article of the present invention, the zinc-silicate glass is further characterized by having a composition comprised essentially, in molar percent, of about 50 to 69% SiO₂, 0 to 13% B₂O₃, 2 to 6.50% Al₂O₃, 0 to 3.90% AlF₃, 10.40 to 17% Na₂O, 0 to 3% NaF, 0 to 18% ZnO, 0 to 3.20% ZrO₂, 0 to 0.80% MgO, 0 to 0.66% BaO, 0 to 6.72% CaO, 0 to 0.075% Sb₂O₃, and 0.08 to 0.11% As₂O₃.

The zinc-silicate glasses of the present invention advantageously do not include potassium, and have only Na as an exchangeable alkali ion species. The fluorine in each exemplary glass leads to a decrease in the general diffusion coefficient, which makes an ion-exchange process more controllable. A larger (than in prior art zinc-silicate glasses) Zn concentration in our glasses is found to weaken the influence of impurities responsible for silver reduction, thus leading to decreased waveguide losses and decreased luminescence. Additionally, the increased zinc concentration leads to improved glass durability in base solutions, which are used in the mask removal process in photolithography.

### BRIEF DESCRIPTION OF THE DRAWINGS

The invention is herein described, by way of example only, with reference to the accompanying drawings, wherein:

FIG. 1 shows the index change variation as function of depth in waveguides prepared by the ion-exchange processes on the glasses of the present invention;

FIG. 2 shows results of luminescence measurements of heat-treated waveguides prepared by ion-exchange;

FIG. 3 shows the effect of fluorine on the general diffusion coefficient in the glasses of the present invention.

### DESCRIPTION OF THE PREFERRED EMBODIMENTS

The designs of modern devices of integrated optics constantly require new optical materials, and in particular new optical glass compositions. The present invention is of optical glasses used in integrated optical waveguides. The present invention is dedicated to development of new optical glass compositions with new characteristics, suited for modern optical telecommunication devices fabricated by ion-exchange technology. More specifically, the present invention is of single alkali metal potassium-free zinc-silicate glasses used as substrates for ion-exchange.

Glass compositions in preferred embodiments of the present invention include, in molar percent, essentially 50-69% SiO₂, 0-13% B₂O₃, 2-6.50% Al₂O₃, 0-3.90% AlF₃, 10.40-17% Na₂O, 0-3% NaF, 0-18% ZnO, 0-3.20% ZrO₂, 0-0.80% MgO, 0-0.66% BaO, 0-6.72% CaO, 0-0.075% Sb₂O₃, and 0.08-0.11% As₂O₃. Molar percent can be easily translated into weight percent, as well known and explained in any basic chemistry book. Fluorine introduced to the glasses through NaF and AlF₃ corresponds to a molar percentage ranging from 0 to 12.8 at%. “Molar” in the previous sentence refers to fluorine as an atomic species (thus that percentage can also be called an “atomic percentage”). Some glasses have CaF₂ as an alternative or additional sources of fluorine, CaF₂ being introduced through substitution of the corresponding amount of CaF₂ for 1 wt % of CaO. Examples of the synthesized glasses and their compositions are given in Table 1.

TABLE 1

| | Mol % | | | | | | | | | | | | |
|---|---|---|---|---|---|---|---|---|---|---|---|---|---|
| | SiO₂ | B₂O₃ | Al₂O₃ | AlF₃ | Na₂O | NaF | ZnO | ZrO₂ | MgO | BaO | CaO | Sb₂O₃ | As₂O₃ |
| DT4Fpr3 | 64 | 0 | 0 | 0 | 13.5 | 3 | 18 | 1.5 | 0 | 0 | 0 | 0 | 0.11 |
| DT10F | 50.9 | 11.8 | 3.9 | 3.9 | 15.7 | 0 | 7.8 | 2.9 | 0 | 0 | 2.9 | 0.066 | 0 |
| DT11F | 51 | 10.8 | 5.9 | 1.97 | 16.7 | 0 | 3.89 | 2.94 | 0 | 0 | 6.72 | 0.061 | 0 |
| DT12F | 56.1 | 11.9 | 6.5 | 2.2 | 10.4 | 0 | 4.3 | 3.2 | 0 | 0 | 5.4 | 0.075 | 0 |
| BT3 | 69 | 12.3 | 2 | 0 | 13.8 | 0 | 0 | 0 | 0.8 | 0.66 | 1.38 | 0 | 0.08 |
| BT4 | 64.5 | 11.3 | 4 | 0 | 15.3 | 0 | 0 | 0 | 0.8 | 0.66 | 3.38 | 0 | 0.11 |
| BT5a | 61.1 | 13 | 4 | 0 | 17 | 0 | 0 | 0 | 0.8 | 0.66 | 3.38 | 0 | 0.11 |
| BT5b | 61.1 | 13 | 4 | 0 | 17 | 0 | 0 | 0 | 0.8 | 0.66 | 3.38 | 0.067 | 0.11 |

| | Mol % | | | | | | | | |
|---|---|---|---|---|---|---|---|---|---|
| | SiO₂ | B₂O₃ | Al₂O₃ | AlF₃ | Na₂O | ZnO | ZrO₂ | Sb₂O₃ | As₂O₃ |
| DT6Fa | 50 | 10 | 4 | 4 | 16 | 15 | 3 | 0.067 | 0 |
| DT6Fb | 50 | 10 | 4 | 4 | 16 | 15 | 3 | 0 | 0.11 |

The compositions in Table 1 are exemplary compositions, and are by no means limiting. The glasses are labeled “DT” and “BT” followed by a number and/or letters. These labels are for identification purposes only. The compositions in Table 1 are in molar percent. In BT3, F was introduced through CaF₂ that was included as 0.5 weight % of CaO. In BT4, BT5a and BT5b, F was introduced through CaF₂, which was included as 1 weight % of CaO. Note that the “BT” glasses do not include NaF or AlF₃. The “DT6” glasses do not include NaF, MgO, BaO and CaO, and therefore receive their fluorine from AlF₃. The glasses of the present invention do not include potassium (i.e. are “potassium-free”).

The glasses of the present invention were prepared in a conventional manner, using both laboratory scale and semi-industrial scale synthesis. The semi-industrial synthesize product was in general a slab with dimensions of between 20/80/100 to about 34/100/145 mm³. The lab scale product was smaller. Chemically pure and high-purity grade commercial reagents were used only. The content of impurities (oxides of Fe, Co, Cr, Mn, V, Cu, etc) in the reagents did not exceed 10⁻⁴ weight percent. Laboratory scale synthesis was performed using 100-ml and 300-ml cristobalite (“C”) crucibles and 100-ml platinum (Pt) crucibles. Semi-industrial scale synthesis was performed using 900-ml cristobalite crucibles and 200 or 750-ml Pt crucibles.

Batches were formulated and mixed in a conventional manner, the batch ingredients were compounded and thoroughly mixed together to secure a homogeneous melt. Each batch of the starting compounds, in their respective proportions, was melted in cristobalite or platinum crucibles at a batch melting temperature Tₘ ranging between about 1420 and about 1485° C., for between about 35 to about 195 minutes. The glasses were then synthesized at temperatures ranging from between about 1420 to about 1470° C. for between about 15 to about 150 minutes, and cooled to around 550° C. for annealing. Detailed synthesis conditions (temperature and time) are listed for each exemplary glass in Tables 2 and 3. Table 2 lists examples of glasses synthesized under laboratory conditions, while Table 3 lists examples of glasses synthesized under semi-industrial conditions.

TABLE 2

| Glass | Tₛ ° C. | tₛ min | Crucible |
|---|---|---|---|
| DT4Fpr3 | 1450 | 20 | C |
| DT4Fpr3 | 1450 | 20 | Pt |
| DT10F | 1420 | 20 | C |
| DT11F | 1440 | 40 | C |
| DT11F | 1480 | 45 | Pt |
| DT12F | 1450 | 60 | Pt |
| BT3 | 1470 | 30 | C |
| BT4 | 1470 | 30 | C |
| BT5a | 1450 | 15 | C |
| BT5b | 1450 | 15 | C |

TABLE 3

| Glass | T_{synt} ° C. | t_{synt} min |
|---|---|---|
| DT6Fa | 1480 | 95 |
| DT6Fb | 1475 | 95 |
| DT4Fpr3 | 1490 | 75 |
| BT3 | 1470 | 150 |

The determination of the chemical stability of each glass was performed in three steps. In the first step, parallelepiped glass samples were treated in boiling water for 10 hours, the samples being weighted before and after this treatment. In the second step, the same samples were exposed to a salt melt of NaNO₃ at 350-360° C. for 24 hours, and then weighted again. The weight change per unit area was then calculated. All glasses demonstrated good chemical stability in water and in the NaNO₃ salt melt, i.e. for a 10×10×10 mm³ sample (about 3 grams), weight loss did not exceed the measurement accuracy (±0.0001 g), or weight loss per unit area did not exceed 1.5×10⁻⁷ g/mm². In the third step, the same glass samples were exposed to a boiling 7M NaOH solution for 8 hours. The glasses demonstrated weight loss below 300×10⁻⁶ g/mm², which, according to our experience, is acceptable for a technological product.

Relevant properties of each of the glasses were measured and are listed in Table 4. These included density and refractive index data measured with a standard refractometer.

TABLE 4

| | Density, | Index N_{F} | Index N_{C} | Dispersion |
|---|---|---|---|---|
| Glass | g/cm³ | at 632.8 nm | at 587.6 nm | Δ = (N_{F} − N_{C}) |
| DT4pr3 | 2.7651 | 1.541 | 1.5443 | 0.0101 |
| DT6FA | 2.7583 | 1.537 | 1.5403 | 0.0099 |
| DT6FB | 2.7583 | 1.537 | 1.5402 | 0.0097 |
| DT10F | 2.6618 | 1.529 | — | — |
| DT11F | 2.6431 | 1.538 | 1.5402 | 0.0092 |
| BT3 | 2.4921 | 1.512 | — | — |
| BT3(2) | — | 1.513 | 1.5148 | 0.0079 |
| BT4 | 2.5065 | 1.515 | — | — |

Table 5 shows the results of an ion-exchange study on several of the exemplary glasses of the present invention. Ion-exchange is used, as explained above, to change the local refractive index in a given region. For example, channel waveguides may be prepared by known masking techniques (e.g. photolithography or shadow masking) whereby only regions open to the silver undergo ion-exchange. The ion-exchange was performed in Teflon crucibles at 340° C. Two salt melts were used, namely Salt 1 consisting of 5 molar % of AgNO₃+sodium-potassium nitrate eutectic, and Salt 2 consisting of 62 molar % of AgNO₃+38 mol % of KNO₃. The duration of the ion-exchange tests is indicated in Table 5. The index increase and the depth of diffusion were determined by a mode spectroscopy technique. Non-listed glasses prepared according to the present invention underwent similar tests.

TABLE 5

| | AgNO₃ concentration | Duration, | | |
|---|---|---|---|---|
| Glass | in salt melt | min | Δn | L, μm |
| DT4Fpr3 | 5 mol % (Salt No. 1) | 150 | 0.093 | 35 |
| DT6Fa | 5 mol % (Salt No. 1) | 150 | 0.035 | 17 |
| | 62 mol % (Salt No. 2) | 100 | 0.084 | 17 |
| DT6Fb | 5 mol % (Salt No. 1) | 150 | 0.035 | 17 |
| | 62 mol % (Salt No. 2) | 100 | 0.088 | 21 |
| DT10F | 5 mol % (Salt No. 1) | 150 | 0.047 | 20 |
| DT11F | 5 mol % (Salt No. 1) | 240 | 0.063 | 25 |
| BT3 | 5 mol % (Salt No. 1) | 240 | 0.043 | 17 |
| | 62 mol % (Salt No. 2) | 100 | 0.082 | 14 |
| BT4 | 5 mol % (Salt No. 1) | 240 | 0.051 | 23 |

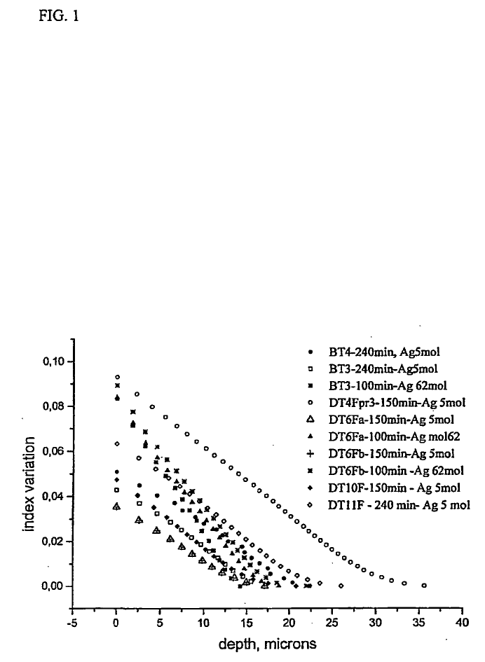

The results of measurements of refraction index change “Δn” as a result of the ion-exchange, and of diffusion length “L” in as-prepared waveguides, are presented in FIG. 1. The ion-exchange conditions are listed near each exemplary glass. For example, “BT4-240 min, Ag5 mol” means that glass BT4 underwent ion-exchange in salt melt No. 1 (5 mol % of AgNO₃) for 240 min. The figure shows the index change variation as function of depth in waveguides prepared by the ion-exchange processes listed in Table 5. The depth is the variable, which corresponds to the normal coordinate calculated from the substrate surface and at which the index variation is measured. The diffusion length L in Table 5 is the length, at which one can see a visible index increase in the waveguide.

Silver reducing was evaluated by a luminescence technique. The luminescence of reduced silver was measured within the specific bandwidth of neutral silver around 16000 cm⁻¹. Waveguides resulting from the ion-exchange were illuminated by an Ar-laser beam incident at 45 degrees to the surface, and the luminescence signal was measured by a detector in an approximately normal direction to the sample surface. The absence of a change in the luminescence signal after the ion-exchange was used as the criterion of silver stability in the glass. All exemplary glasses prepared according to the present invention demonstrated the absence of silver reducing, which is a positive feature essential for the use of these glasses in passive optical components such as waveguides.

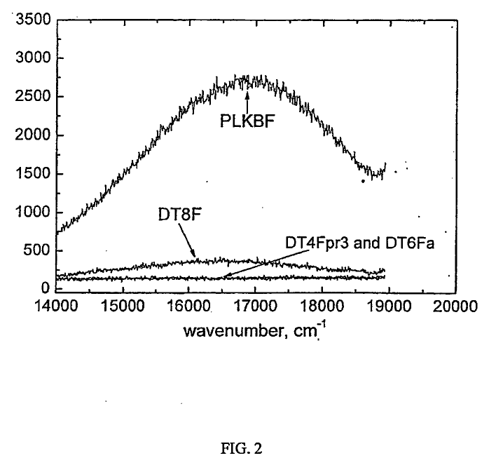

The waveguides were further heat-treated at 100-180° C. for 10 days. All glasses listed in Table 5 and shown in FIG. 1 demonstrated an absence of silver reducing after heat treatment. This is a key indication of the usefulness of these glasses for integrated optics applications. Exemplary results of luminescence measurements of all heat-treated waveguides are shown in FIG. 2. “Good” glasses are expected to show no change or very little change in the luminescence spectra (height of the band at 16000 cm⁻¹) after heat-treatment vs. the original (no heat-treated) condition. The lower that height, the better the glass. Thus, a lack of luminescence indicates a good glass, while a high luminescence peak indicates a “bad” glass. FIG. 2 shows two “excellent” exemplary glasses (DT4pr3 and DT6Fa) vs. two “bad” glasses (DT8F and PLKBF).

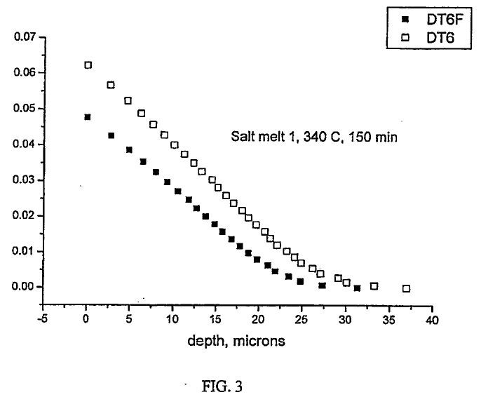

FIG. 3 shows the effect of fluorine on the general diffusion coefficient in the zinc-silicate glasses of the present invention. Glass DT6F has the same general composition as glasses DT6Fa and DT6Fb, but does not contain F. It is clear from the figure that diffusion if faster in DT6 than in DT6A.

In summary, although fluorinated glasses are used in the field of optical communication, the applications of these glasses is limited to active components. In these components, fluorinated glasses improve quantum yield and flatten the gain in lanthanides amplifiers (equalizing the gain for all amplified wavelength), and reduce propagation losses caused by overtones vibration absorption of OH groups in phosphate glasses. In contrast, the fluorinated glasses described in the present invention can be used for passive components (optical waveguides) and some (e.g. DT4, DT6) include Zn concentrations larger than those of U.S. Pat. No. 6,128,430. The introduction of F in glasses leads to a decrease in the general diffusion coefficient, which makes an ion-exchange process more controllable. We also found that increasing the Zn concentration in glass weakens the influence of impurities responsible for silver reduction, in particular Fe²⁺. This leads to decreased waveguide losses and decreased luminescence. Additionally, an increased zinc concentration leads to improved glass durability in base solutions, which are used in the mask removal process in photolithography.

The glasses provided by the present invention substantially enlarge the possibilities of making passive components such as waveguides in integrated optical system. These glasses have only one alkali metal ion-exchangeable in an ion-exchange process, in contrast to the prevalent two alkali metal ion glasses used at present.

All publications, patents and patent applications mentioned in this specification are herein incorporated in their entirety by reference into the specification, to the same extent as if each individual publication, patent or patent application was specifically and individually indicated to be incorporated herein by reference in addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A fluorinated zinc-silicate glass having a composition comprised essentially, in molar percent, of about 50 to 69% SiO₂, 0 to 13% B₂O₃, 2 to 6.50% Al₂O₃, 0 to 3.90% AlF₃, 10.40 to 17% Na₂O, 0 to 3% NaF, 0 to 18% ZnO, 0 to 3.20% ZrO₂, 0 to 0.80% MgO, 0 to 0.66% BaO, 0 to 6.72% CaO, 0 to 0.075% Sb₂O₃, and 0.08 to 0.11% As₂O₃.

2. The fluorinated zinc-silicate glass of claim 1, wherein said composition further includes in weight percent about 0 to 1 wt % CaF₂.

3. The fluorinated zinc-silicate glass of claim 1, wherein said NaF and said AlF₃ provide between about 0 and about 12.8 molar percent fluorine.

4. The fluorinated zinc-silicate glass of claim 1, wherein the glass has a refractive index at 632.8 nm of between 1.512 and 1.541, and a refractive index at 587.6 nm of between 1.514 and 1.544.

5. The fluorinated zinc-silicate glass of claim 1, wherein said Na₂O provides a Na ion species for ion-exchange processes, whereby the zinc-silicate glass is a single exchangeable alkali ion glass.

6. An optical article fabricated in a planar slab of a fluorinated zinc-silicate glass by an ion-exchange process, the zinc-silicate glass characterized by having a single alkali ion species for said ion-exchange.

7. The optical article of claim 6, wherein said zinc-silicate glass is further characterized by having a composition comprised essentially, in molar percent, of about 50 to 69% SiO₂, 0 to 13% B₂O₃, 2 to 6.50% Al₂O₃, 0 to 3.90% AlF₃, 10.40 to 17% Na₂O, 0 to 3% NaF, 0 to 18% ZnO, 0 to 3.20% ZrO₂, 0 to 0.80% MgO, 0 to 0.66% BaO, 0 to 6.72% CaO, 0 to 0.075% Sb₂O₃, and 0.08 to 0.11% As₂O₃.

8. The optical article of claim 7, wherein said glass is further characterized by having a refractive index at 632.8 nm of between 1.512 and 1.541, and a refractive index at 587.6 nm of between 1.514 and 1.544.

9. The optical article of claim 7, wherein said single exchangeable alkali ion is a sodium ion.

10. The optical article of claim 9, wherein said ion-exchange process includes exchanging silver for said sodium in defined areas of said glass.

11. The optical article of claim 10, wherein said ion-exchange provides an optical waveguiding path characterized by an increased refraction index relative to areas surrounding said path.
